(19) United States
(12) Patent Application Publication
(10) Pub. No.: US 2012/0051571 A1
(43) Pub. Date: Mar. 1, 2012

(54) Audio communication system

(76) Inventor: James J. Charvat, JR., Valley, NE (US)

(21) Appl. No.: 12/806,990

(22) Filed: Aug. 25, 2010

(51) Int. Cl. H04R 1/02; A41D 27/20; A41D 1/00

(52) U.S. Cl. 381/333; 2/115; 2/247

(57) ABSTRACT

An audio communication system is disclosed to enable a person addressing a group of people to be heard regardless of whether the people to whom the person is addressing or regardless of whether the person is being addressed is faced by the person giving the speech, from the rear of the person giving the speech or to either side of the person giving the speech. The garment of this invention which is to be worn by the person addressing the group of people includes wireless loudspeakers at the front of the garment at the rear of the garment and at the sleeves of the garment. In a modified embodiment, the microphone and loudspeakers are hard wired together.

Your Petitioner, JAMES J. CHARVAT, JR., a citizen of the United States and a resident of the State of Nebraska, whose post office address is 2194 Shunk Road, Valley, Nebr. 68064 prays that Letters Patent may be granted to him for the invention set forth in the following specification.

### BACKGROUND OF THE INVENTION

1. Field of the Invention

This invention relates an audio communication system and more particularly to a garment which is worn by a person speaking to a plurality of persons who at least partially surround the person. Even more particularly, this invention relates to a garment such as a shirt or the like having a pair of wireless loudspeakers positioned at the front side of the garment, a pair of wireless loudspeakers positioned at the back side of the garment, and a wireless loudspeaker positioned at each of the sleeves of the garment. The person wearing the garment has a wireless microphone which is in wireless communication with the loudspeakers.

2. Description of the Related Art

In many situations, a person will be speaking to a group of people such as in a sports training session wherein the person addressing the group of people will be at least partially surrounded by the group of people to which the speaker is addressing. If the person who is addressing the group of people is facing away from some of the people in the group, those people will have difficulty in hearing the person. The same is true for persons such as guides in a museum, art gallery, etc.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A garment is provided which is to be worn by a person speaking to a group of people who at least partially surround the person. The garment to be worn by the person may be a shirt, sleeveless vest, etc. The shirt to be worn by the person includes a front portion, a back portion and a pair of sleeves. A pair of wireless loudspeakers is positioned on the front portion of the shirt which is in wireless communication with a wireless microphone which is worn by the person addressing the group of people. A pair of wireless loudspeakers is also positioned on the back portion of the shirt which are in wireless communication with the wireless microphone. A wireless loudspeaker is positioned on each of the sleeves of the shirt which are in communication with the wireless microphone.

Even if the person addressing the group of people is facing away from the group of people, the wireless microphones on the back portion of the garment or the sleeves thereof will direct the person's speech to the group of people which are not faced by the person giving the speech.

It is therefore a principal object of the invention to provide a garment which is to be worn by a person speaking to a group of people with the garment having wireless microphones positioned at the front portion of the garment, wireless speakers at the back portion of the garment and a wireless speaker on each of the sleeves of the garment.

A further object of the invention is to provide an apparatus which enables a group of people to be clearly heard by a person addressing a group of people regardless of whether the person making the speech is facing the group of people or not.

A further object of the invention is to provide a garment having a plurality of wireless loudspeakers positioned in pockets in the front portion of the garment, the back portion of the garment, and in the sleeves of the garment.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a front perspective view of a person wearing a wireless microphone and a garment including wireless loudspeakers;

FIG. 2 is a front view of the garment of FIG. 1;

FIG. 3 is a back view of the garment of FIG. 1;

FIG. 4 is a front perspective view illustrating the manner in which the wireless microphones are selectively removably positioned in pockets in the garment; and

FIG. 5 is a top view illustrating the manner in which the loudspeakers of the garment of FIG. 1 direct sound to a plurality of persons surrounding the person addressing the same.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

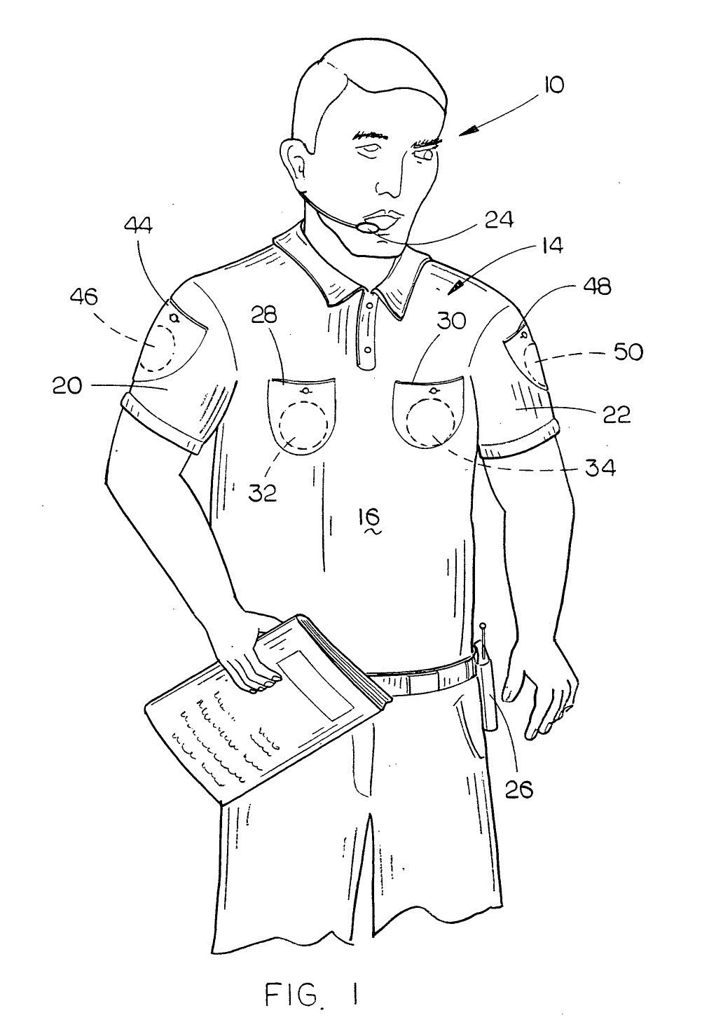

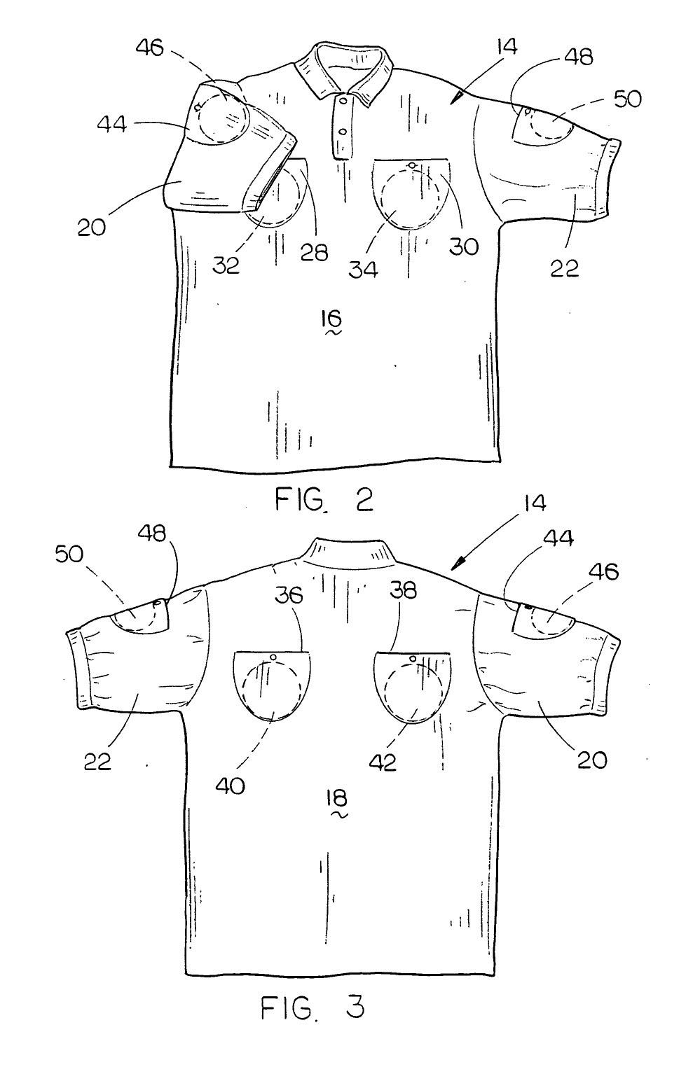

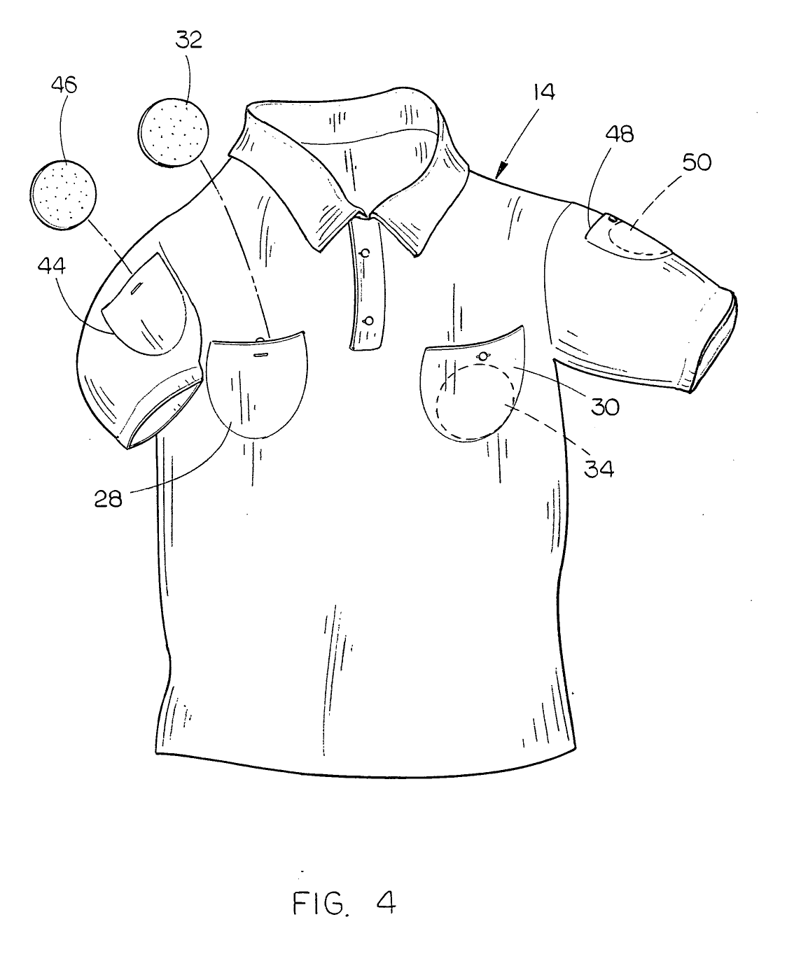

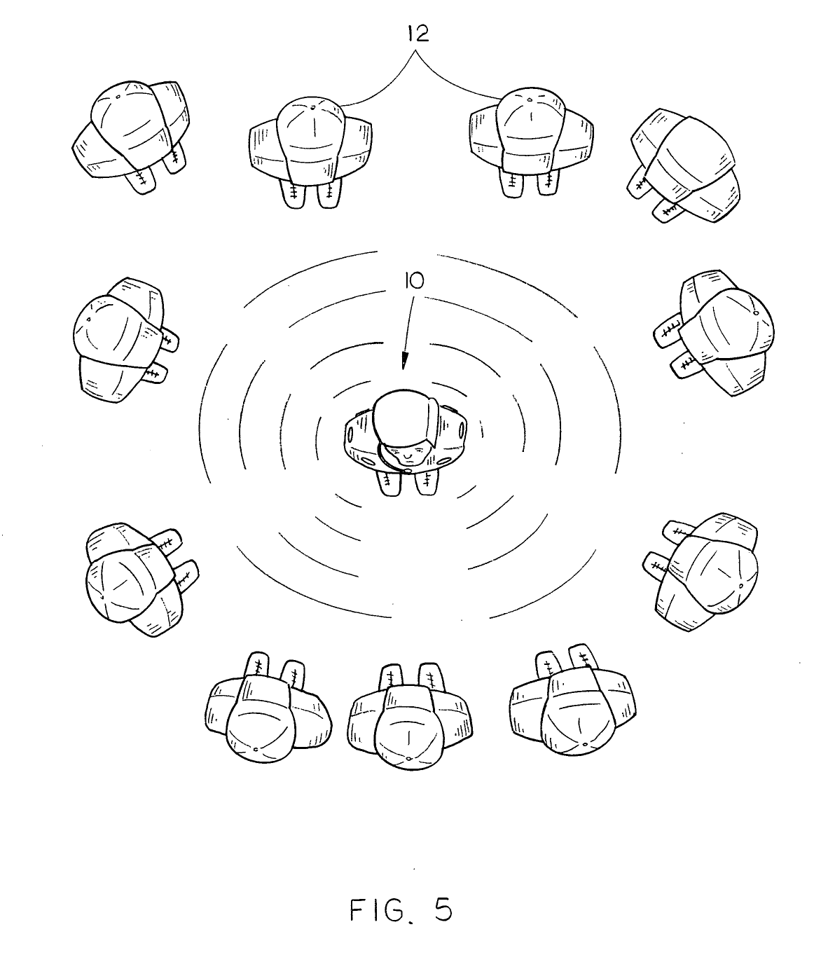

In FIGS. 1 and 5, the numeral 10 refers to a person who is speaking to a plurality of people who at least partially surround the person, as illustrated in FIG. 5. Those persons listening to the person addressing the same are designated by the reference numeral 12.

The person 10 is wearing a garment such as a shirt 14 which includes a front portion 16, back portion 18, and sleeves 20 and 22. The garment 14 could be sleeveless such as would be possible with a sleeveless vest or the like but it is preferred that the garment 14 have sleeves.

The person 10 is shown as wearing a wireless microphone 24 of conventional design. The wireless microphone could also be clipped onto the shirt of the person wearing the same. The wireless microphone 24 is electronically connected to the battery pack 26 which is preferably mounted on the person wearing the same. The wireless microphone 24 communicates with the battery pack and transmitter 26 which transmits the voice messages of the person 10 to the loudspeakers worn by the person as will now be described.

The front portion of garment 14 includes a pair of spaced-apart pockets 28 and 30 which is adapted to receive conventional wireless loudspeakers 32 and 34 respectively. The back portion 18 of garment 14 includes a pair of spaced-apart pockets 36 and 38 which is adapted to selectively removably receive the wireless loudspeakers 40 and 42 respectively.

Sleeve 20 is provided with a pocket 44 which is adapted to selectively removably receive a conventional wireless loudspeaker 46 therein. Sleeve 22 is provided with a pocket 48 which is adapted to selectively removably receive a conventional wireless loudspeaker 50 therein.

In use, the speaker 10 will have the wireless microphone 24 either secured to the person's head or to a clip-on device so that any speech or audio messages by the person 10 will be wirelessly communicated to the loudspeakers 32, 34, 36, 38, 46 and 50. Thus, no matter which way the person 10 is facing, those people surrounding that person, as illustrated in FIG. 5, will be able to hear the message of that speaker since the loudspeakers will direct the person's audio comments to the front of the person, to the rear of the person, and to either side of the person.

The fact that the wireless microphones of conventional design are selectively removably positioned in pockets on the garment enables the garment to be laundered or dry cleaned.

Although it is preferred that the microphone is wirelessly connected to the loudspeakers, they could be hard wired together through the battery pack.

Thus it can be seen that a novel apparatus has been provided which enables persons surrounding a person speaking to the group to hear the comments of the person regardless of whether the persons in the group are behind the speaker, or at either side of the speaker. It can therefore be seen that the invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. In combination:
a wireless microphone to be worn by a person speaking to a group of people who are at least partially positioned around the person;
a shirt to be worn by the said person which includes a front portion, a back portion and a pair of sleeves;
at least one wireless loudspeaker positioned on said front portion of said shirt which is in wireless communication with said wireless microphone;
at least one wireless loudspeaker positioned on said back portion of said shirt which is in wireless communication with said wireless microphone;
and at least one wireless loudspeaker positioned on each of said sleeves which is in wireless communication with said wireless microphone.

2. The combination of claim 1 wherein a pair of spaced-apart loudspeakers is positioned on said front portion of said shirt.

3. The combination of claim 1 wherein a pair of spaced-apart wireless loudspeakers is positioned on said back portion of said shirt.

4. The combination of claim 1 wherein said shirt has: at least one pocket provided on said front portion of said shirt; at least one pocket provided on said back portion of said shirt; and at least one pocket positioned on each of said sleeves and wherein said wireless loudspeakers are selectively removably positioned in said pockets.

5. The combination of claim 2 wherein said shirt has a pair of pockets on said front portion of said shirt and wherein said wireless loudspeakers are selectively removably positioned in said pockets.

6. The combination of claim 3 wherein said shirt has a pair of pockets on said back portion of said shirt and wherein said wireless loudspeakers are selectively removably positioned in said pockets.

7. In combination:
a wireless microphone to be worn by a person speaking to a group of people who are at least partially positioned around the person;
a garment to be worn by the said person on the person's upper body with the garment including a front portion and a back portion;
and at least one wireless loudspeaker positioned on said back portion of said garment which is in wireless communication with said wireless microphone.

8. The combination of claim 7 wherein said back portion of said garment has a pocket positioned therein and wherein said wireless loudspeaker is selectively removably positioned in said pocket.

9. The combination of claim 7 wherein at least one wireless loudspeaker is positioned on said front portion of said garment which is in wireless communication with said wireless microphone.

10. The combination of claim 9 wherein said front portion of said garment has a pocket positioned thereon and wherein said wireless loudspeaker is selectively removably positioned in said pocket.

11. In combination:
a microphone to be worn by a person speaking to a group of people who are at least partially positioned around the person;
a shirt to be worn by the said person which includes a front portion, a back portion and a pair of sleeves;
at least one loudspeaker positioned on said front portion of said shirt which is in communication with said microphone;
at least one loudspeaker positioned on said back portion of said shirt which is in communication with said microphone;
and at least one loudspeaker positioned on each of said sleeves which is in communication with said microphone.

12. The combination of claim 11 wherein a pair of spaced-apart loudspeakers is positioned on said front portion of said shirt.

13. The combination of claim 11 wherein a pair of spaced-apart loudspeakers is positioned on said back portion of said shirt.

14. The combination of claim 11 wherein said shirt has: at least one pocket provided on said front portion of said shirt; at least one pocket provided on said back portion of said shirt; and at least one pocket positioned on each of said sleeves and wherein said loudspeakers are selectively removably positioned in said pockets.

15. The combination of claim 12 wherein said shirt has a pair of pockets on said front portion of said shirt and wherein said loudspeakers are selectively removably positioned in said pockets.

16. The combination of claim 13 wherein said shirt has a pair of pockets on said back portion of said shirt and wherein said loudspeakers are selectively removably positioned in said pockets.

17. In combination:
a microphone to be worn by a person speaking to a group of people who are at least partially positioned around the person;
a garment to be worn by the said person on the person's upper body with the garment including a front portion and a back portion;
and at least one loudspeaker positioned on said back portion of said garment which is in communication with said microphone.

18. The combination of claim 17 wherein said back portion of said garment has a pocket positioned therein and wherein said loudspeaker is selectively removably positioned in said pocket.

19. The combination of claim 17 wherein at least one loudspeaker is positioned on said front portion of said garment which is in communication with said microphone.

20. The combination of claim 19 wherein said front portion of said garment has a pocket positioned thereon and wherein said loudspeaker is selectively removably positioned in said pocket.
